(19) United States
(12) Patent Application Publication
(10) Pub. No.: US 2018/0111534 A1
(43) Pub. Date: Apr. 26, 2018

(54) 4 Cup Carrier Tray Holder

(71) Applicants: Jeffrey A. Fassler, Smithown, NY (US); Constantine M. Chonis, Kings Park, NY (US)

(72) Inventors: Jeffrey A. Fassler, Smithown, NY (US); Constantine M. Chonis, Kings Park, NY (US)

(21) Appl. No.: 15/331,835

(22) Filed: Oct. 22, 2016

(51) Int. Cl. B60N 3/10

(52) U.S. Cl. CPC B60N 3/103

(57) ABSTRACT

The 4 Cup Carrier Tray Holder is an invention designed to Level and Secure a common 4 Cup Carrier Tray with Beverages on a Car, SUV, or Truck seat. This is accomplished from the wedge shape and pocket design that levels and holds these commonplace beverage carrier trays provided at multiple convenience stores to hold multiple beverages. The Invention reduces dangerous driver distraction and captures any spillage.

### CROSS-REFERENCE TO RELATED APPLICATION

Provision Patent Application #62384117 filed on Sep. 6, 2016

### FIELD OF INVENTION

The present invention relates to securely and safely transporting a common 4-Cup Carrier Tray with Beverages in a Car, SUV or Truck Vehicle seat. Presently there is no solution for securing a common 4-Cup Carrier Tray with Beverages.

### BACKGROUND OF THE INVENTION

Current 4-Cup Carrier Trays are not stable and secure in a vehicle for transport. The existing 4-Cup Carrier Trays provided by various coffee and beverage sellers do not sit level on a vehicle seat and shift easily when driving over bumpy roads and making turns. This causes unsafe driver distraction and drink spillage while driving. There is presently no solution available for securing a 4-Cup Carrier Tray with Beverages for transport in a vehicle.

### SUMMARY OF INVENTION

The current invention, 4-Cup Carrier Tray Holder, safely secures these common 4-Cup Carrier Trays for transportation in a vehicle reducing unsafe driver distraction and spillage. This is accomplished by leveling and securely holding the 4-Cup Carrier Tray on a vehicle seat.

### DETAILED DESCRIPTION OF THE INVENTION

### Using the Invention

The invention is placed on a vehicle seat as depicted in the 4 Cup Carrier Tray Holder Functional Drawing included in this application.

When multiple beverages are purchased and carried from the store in a 4 Cup Carrier Tray (i.e., holds 4 beverages), they are placed in the invention to secure them during transport. The invention secures the beverages, reducing unsafe driver distraction, and capturing minor spillage.

Prior to this invention, drivers have been seen placing the 4 Cup Carrier Tray with Beverages in various unstable locations within the vehicle. Many drivers have been seen with one hand attempting to hold the beverages securely causing significant unsafe driver distraction.

### Manufacture of the Invention

The Invention is manufactured out of various recycled plastics by the process of Injection Molding.

### DESCRIPTION OF DRAWINGS

### Drawing 1

Drawing 1 illustrates three views of the Invention supporting the feature specified in Claim I—Leveling Angle.

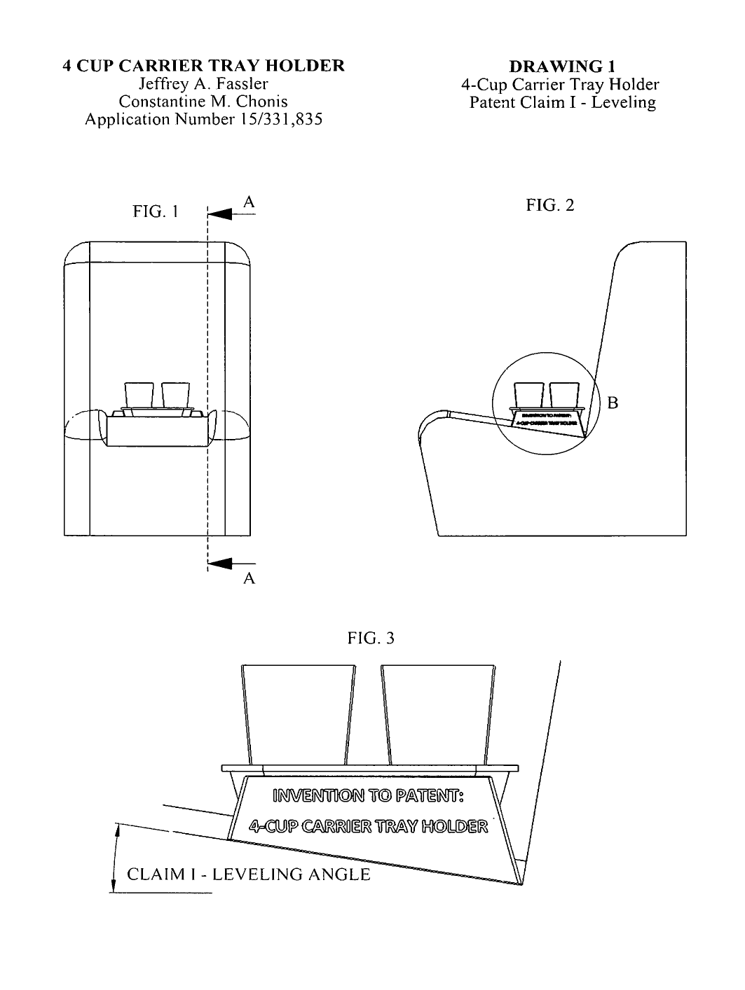

Drawing 1, FIG. 1 shows the invention with 4 Cup Carrier Tray and Beverages sitting on a car seat from a front orientation.

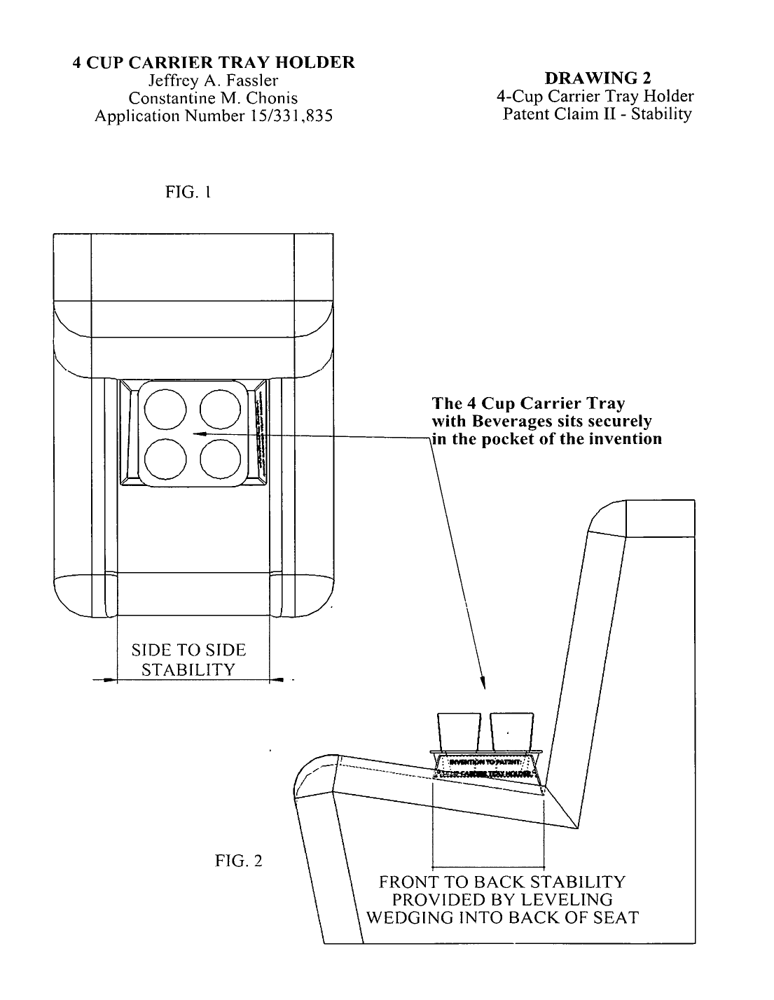

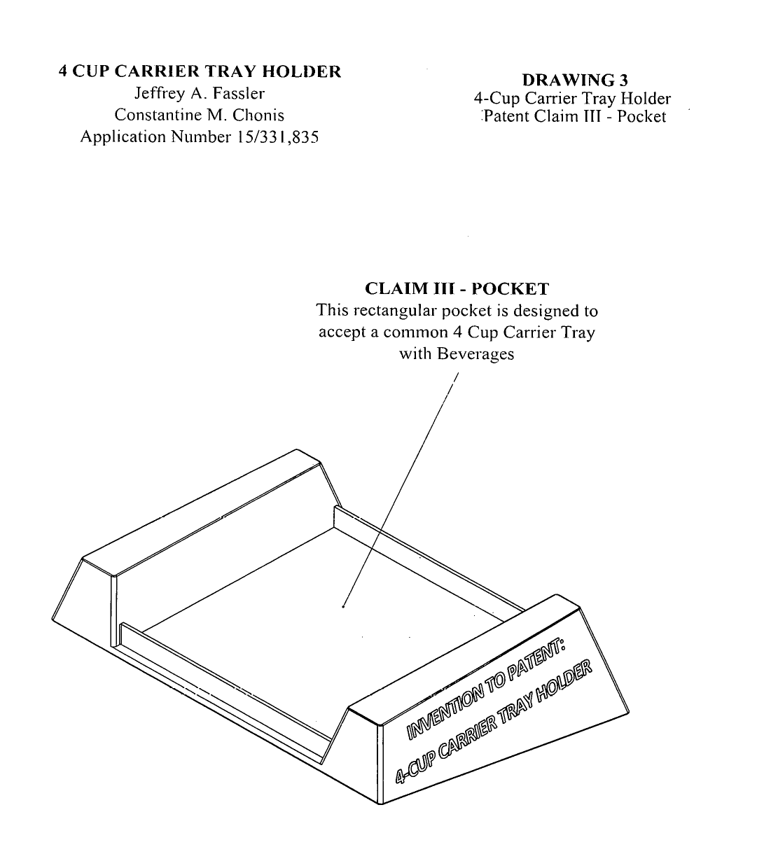

Drawing 1, FIG. 2 shows the invention with 4 Cup Carrier Tray and Beverages sitting on a car seat from a side orientation.

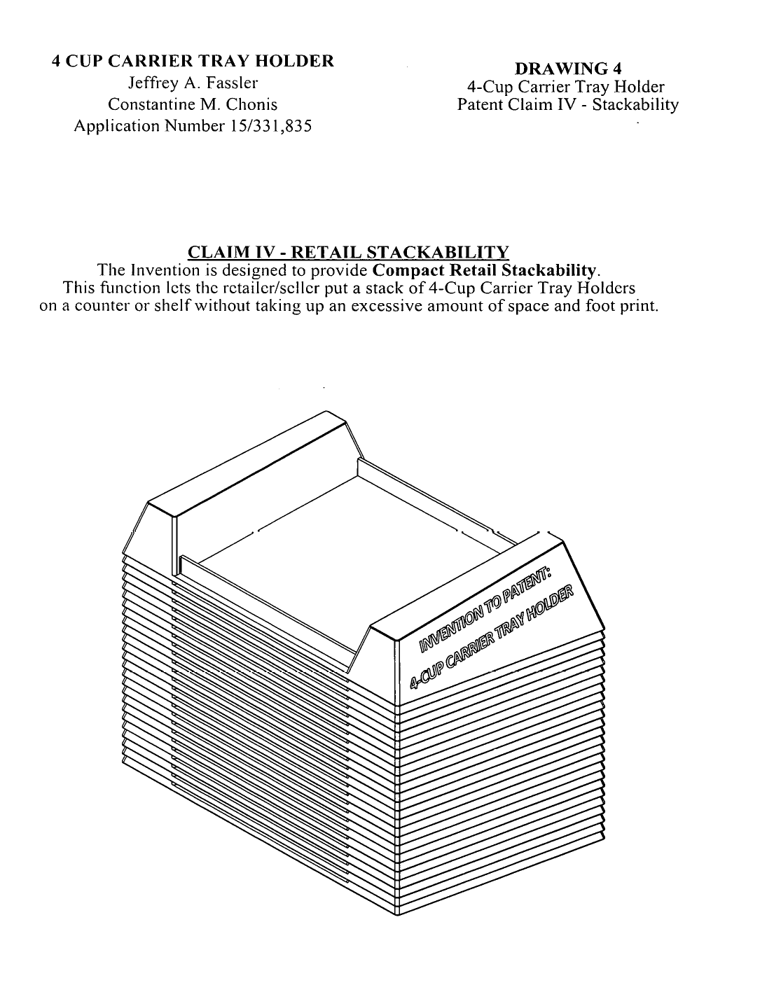

Drawing 1, FIG. 3 shows a larger view of the invention with 4 Cup Carrier Tray and Beverages sitting on a car seat from a side orientation. FIG. 3 specifically points out the leveling feature of the invention.

### Drawing 2

Drawing 2 illustrates two views of the invention supporting the feature specified in Claim II—Stability.

Drawing 2, FIG. 1 shows the invention with 4 Cup Carrier Tray and Beverages sitting on a car seat from a top orientation. The width of the invention provides side to side stability.

Drawing 2, FIG. 2 shows the invention with 4 Cup Carrier Tray and Beverages sitting on a car seat from a side orientation. The leveling angle and wedge shape provide front to back stability by leveling and wedging into the back rest of the seat.

### Drawing 3

Drawing 3 illustrates one view of the invention pocket feature design to hold a 4 Cup Carrier Tray with Beverages level and secure. This drawing supports Claim III—Pocket Design.

### Drawing 4

Drawing 4 illustrates one view of 25 copies of the invention stacked in very compact stack supporting Claim IV—Stackability.

I. A wedge shaped tray with a pocket design having angled retaining walls specifically designed to level, hold and secure a common 4 Cup Carrier Pulp Drink Tray with Beverages on a car seat.

II. (canceled).

III. (canceled).

IV. (canceled).
